(19) United States
(12) Patent Application Publication
(10) Pub. No.: US 2017/0289301 A1
(43) Pub. Date: Oct. 5, 2017

(54) CACHING SHARED CONTENT IN DISTRIBUTED SYSTEMS

(71) Applicant: International Business Machines Corporation, Armonk, NY (US)

(72) Inventors: Vladimir Gamaley, Rehovot (IL); Avi Ribchinsky, Ashdod (IL)

(21) Appl. No.: 15/084,583

(22) Filed: Mar. 30, 2016

(51) Int. Cl. H04L 29/08

(52) U.S. Cl. CPC H04L 67/2852

(57) ABSTRACT

An indication from a first user is received. The indication includes uploading a first file to transfer the firs file from the first user to a second user. A social graph is determined. Whether the first file is stored in a repository associated with any user found in the social graph is determined. Responsive to determining the first file is stored in the repository of any of the users found in the social graph, a link to the first file found in the repository is transmitted to the second user. Responsive to determining the first file is not stored in the repository of any of the users found in the social graph, the first file is uploaded. Responsive to uploading the first file, the uploaded first file is transmitted to the second user.

### BACKGROUND OF THE INVENTION

The present invention relates generally to the field of content sharing, and more particularly to caching shared content.

A cache is a component that stores data on a computing device so that future requests for the stored data can be retrieved quickly. The data stored in a cache may be the result of an earlier computation, or the duplicate of data stored elsewhere. A social graph is a graph that depicts the personal relationships of users and can represent a global mapping of users and how the users are related. Users of social media often have a network that includes various individuals with varying degrees of relationships. The network of individuals can be represented in the form of a social graph, depicting the relationships that the individuals in the network have with a particular user.

### SUMMARY

Embodiments of the present invention include a method, computer program product, and system for storing and referencing shared files. In one embodiment, an indication from a first user is received. The indication includes uploading a first file to transfer the firs file from the first user to a second user. A social graph is determined. Whether the first file is stored in a repository associated with any user found in the social graph is determined. Responsive to determining the first file is stored in the repository of any of the users found in the social graph, a link to the first file found in the repository is transmitted to the second user. Responsive to determining the first file is not stored in the repository of any of the users found in the social graph, the first file is uploaded. Responsive to uploading the first file, the uploaded first file is transmitted to the second user.

### BRIEF DESCRIPTION OF THE DRAWINGS

FIG. 1 is a functional block diagram illustrating a computing environment, in accordance with an embodiment of the present invention;

FIG. 2 is a flowchart of operational steps of a cache program storing and referencing shared files; and

FIG. 3 depicts a block diagram of components of the computing device of FIG. 1, in accordance with an embodiment of the present invention.

### DETAILED DESCRIPTION

Embodiments of the present invention recognize that large amounts of data stored on social media servers are growing at a rapid rate. Advantages of some embodiments of the invention include: (i) a more efficient way to save data to social media servers, (ii) a way to reduce the amount of data stored to social media servers, (iii) a fast way to identify data that is stored on social media servers, and (iv) the ability to perform a search for a select group of individuals.

The present invention will now be described in detail with reference to the Figures.

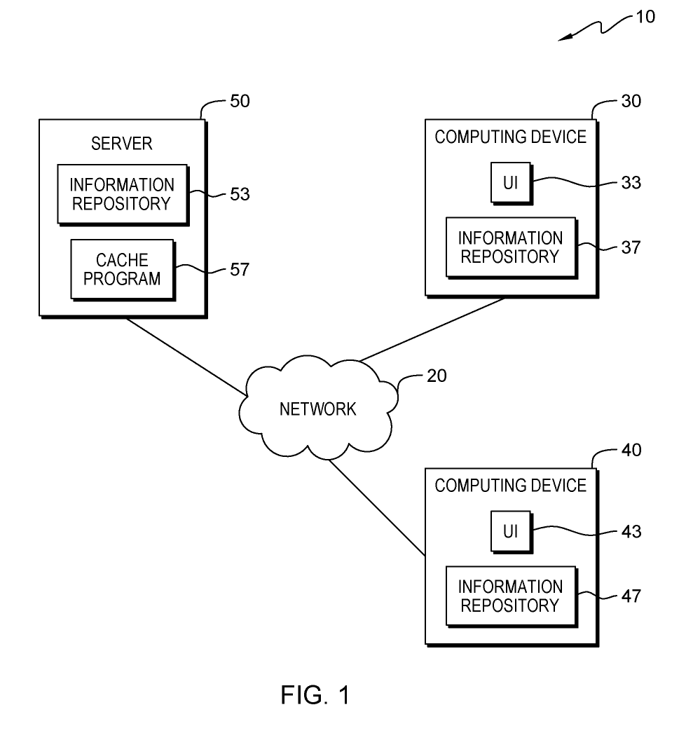

FIG. 1 depicts a diagram of computing environment 10 in accordance with one embodiment of the present invention. FIG. 1 provides an illustration of one embodiment and does not imply any limitations with regard to the environments in which different embodiments may be implemented.

In the depicted embodiment, computing environment 10 includes computing device 30, computing device 40, and server 50 interconnected over network 20. Network 20 may be a local area network (LAN), a wide area network (WAN) such as the Internet, any combination thereof, or any combination of connections and protocols that will support communications between computing device 30, computing device 40, and server 50 in accordance with embodiments of the present invention. Network 20 may include wired, wireless, or fiber optic connections. Computing environment 10 may include additional computing devices, servers, or other devices not shown.

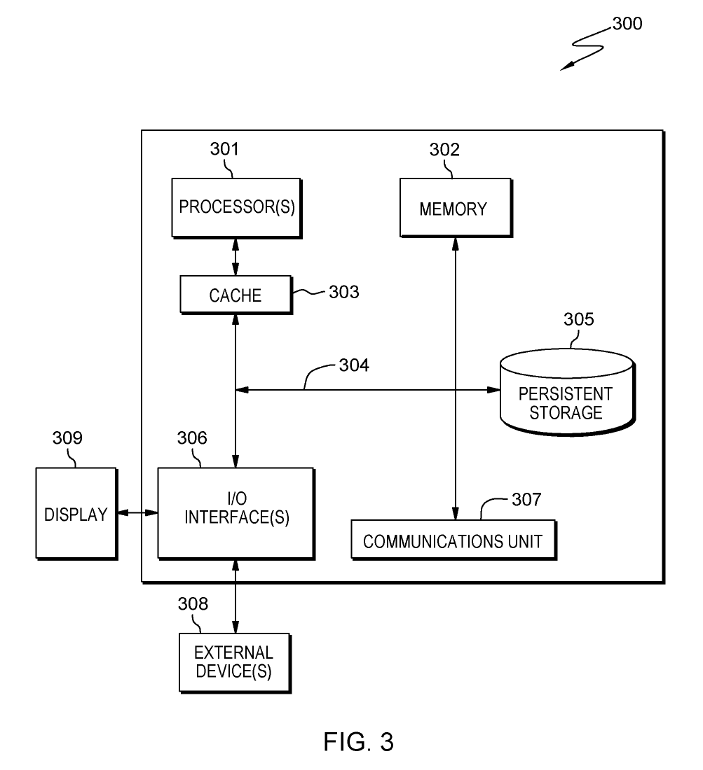

Computing device 30 may be a desktop computer, laptop computer, tablet computer, personal digital assistant (PDA), or smart phone. In general, computing device 30 may be any electronic device or computing system capable of executing computer readable program instructions, and communicating with computing device 40 and server 50 over network 20. In an embodiment, computing device 30 contains user interface (UI) 33 and information repository 37. Computing device 30 may include components as depicted and described in further detail with respect to FIG. 3.

UI 33 operates on computing device 30 to visualize content, such as menus and icons, and to allow a user to interact with an application accessible to computing device 30. In an embodiment, UI 33 comprises an interface to cache program 57. UI 33 may display data received from cache program 57 and send input received from a user of computing device 30 to cache program 57. In other embodiments, UI 33 may comprise one or more interfaces such as, an operating system interface and/or application interfaces. In example embodiments, a user of computing device 30, via UI 33, communicates with cache program 57.

A user interface, as shown by UI 33, is a program that provides an interface between a user and an application. A user interface refers to the information (such as graphic, text, and sound) a program presents to a user and the control sequences the user employs to control the program. There are many types of user interfaces. In an embodiment, the user interface may be a graphical user interface (GUI). A GUI is a type of user interface that allows users to interact with electronic devices, such as a keyboard and mouse, through graphical icons and visual indicators, such as secondary notations, as opposed to text-based interfaces, typed command labels, or text navigation. The actions in GUIs are often performed through direct manipulation of the graphics elements.

In an embodiment, information repository 37 is a repository that may be written to and/or read by cache program 57. In an embodiment, information repository 37 stores data such as, but not limited to, resources (e.g., files, images, documents, etc.) and contacts included in the social network of a user. In an embodiment, contacts are individual users included in the social graph of a user in the social network. In some embodiments, information repository 37 resides on computing device 30. In other embodiments, information repository 37 may reside on another server, or another computing device, provided that information repository 37 is accessible to cache program 57 over network 20.

Information repository 37 may be implemented using any volatile or non-volatile storage media for storing information, as known in the art. For example, information repository 37 may be implemented with a tape library, optical library, one or more independent hard disk drives, or multiple hard disk drives in a redundant array of independent disks (RAID). Similarly, information repository 37 may be implemented with any suitable storage architecture known in the art, such as a relational database, an object-oriented database, or one or more tables.

Computing device 40 may be a desktop computer, laptop computer, tablet computer, personal digital assistant (PDA), or smart phone. In general, computing device 40 may be any electronic device or computing system capable of executing computer readable program instructions, and communicating with computing device 30 and server 50 over network 20. In an embodiment, computing device 30 contains UI 43 and information repository 47. Computing device 40 may include components as depicted and described in further detail with respect to FIG. 3.

UI 43 operates on computing device 40 to visualize content, such as menus and icons, and to allow a user to interact with an application accessible to computing device 40. In an embodiment, UI 43 comprises an interface to cache program 57. UI 43 may display data received from cache program 57 and send input received from a user of computing device 40 to cache program 57. In other embodiments, UI 43 may comprise one or more interfaces such as, an operating system interface and/or application interfaces. In example embodiments, a user (through input via UI 43) of computing device 40 communicates with cache program 57.

A user interface, as shown by UI 43, is a program that provides an interface between a user and an application. A user interface refers to the information (such as graphic, text, and sound) a program presents to a user and the control sequences the user employs to control the program. There are many types of user interfaces. In an embodiment, the user interface may be a graphical user interface (GUI). A GUI is a type of user interface that allows users to interact with electronic devices, such as a keyboard and mouse, through graphical icons and visual indicators, such as secondary notations, as opposed to text-based interfaces, typed command labels, or text navigation. The actions in GUIs are often performed through direct manipulation of the graphics elements.

In an embodiment, information repository 47 is a repository that may be written to and/or read by cache program 57. In an embodiment, information repository 47 stores data such as, but not limited to, resources (e.g., files, images, documents, etc.) and contacts included within the social network of a user. In some embodiments, information repository 47 resides on computing device 40. In other embodiments, information repository 47 may reside on another server, or another computing device, provided that information repository 47 is accessible to cache program 57 over network 20.

Information repository 47 may be implemented using any volatile or non-volatile storage media for storing information, as known in the art. For example, information repository 47 may be implemented with a tape library, optical library, one or more independent hard disk drives, or multiple hard disk drives in a redundant array of independent disks (RAID). Similarly, information repository 47 may be implemented with any suitable storage architecture known in the art, such as a relational database, an object-oriented database, or one or more tables.

Server 50 may be a management server, a web server, or any other electronic device or computing environment capable of processing computer readable program instructions, and receiving and sending data over network 20. In other embodiments, server 50 may be a laptop computer, tablet computer, personal computer (PC), a desktop computer, or any programmable electronic device capable of communicating with computing device 30 and computing device 40 via network 20. In other embodiments, server 50 may represent a server computing environment utilizing multiple computers as a server system, such as in a cloud computing environment. In another embodiment, server 50 represents a computing environment utilizing clustered computers and components to act as a single pool of seamless resources. In an embodiment, server 50 includes information repository 53 and cache program 57. Server 50 may include components as depicted and described in further detail with respect to FIG. 3.

In an embodiment, information repository 53 is a repository that may be written to and/or read by cache program 57. In an embodiment, information repository 53 stores data such as, but not limited to, resources (e.g., files, images, documents, etc.), social graphs, metadata, and a reference link that is associated with a file. In an embodiment, a social graph is a depiction of interactions between groups of users (will be discussed later in more detail). In an embodiment, metadata includes the name of the file, the type of file (e.g., document or photo), the type of extension that is associated with the file (e.g., “.pdf” or “.JPEG”), the name the of creator(s) and/or editor(s), the date and/or time the file was created and/or edited, and any other data that is associated with a file that could be used to identify the file. For example, the metadata may include the origin of the file or list of people who shared the file. In some embodiments, information repository 53 resides on server 50. In other embodiments, information repository 53 may reside on another server, or another computing device, provided that information repository 53 is accessible to cache program 57 over network 20.

Information repository 53 may be implemented using any volatile or non-volatile storage media for storing information, as known in the art. For example, information repository 53 may be implemented with a tape library, optical library, one or more independent hard disk drives, or multiple hard disk drives in a redundant array of independent disks (RAID). Similarly, information repository 53 may be implemented with any suitable storage architecture known in the art, such as a relational database, an object-oriented database, or one or more tables.

In an embodiment, cache program 57 operates to store and reference shared files. In an embodiment, when a user attempts to upload a file, cache program 57 searches information repository 53 for metadata stored to information repository 37 that matches the metadata of the file a user is attempting to upload. In an embodiment, if cache program 57 finds a file in information repository 53 with metadata that matches the metadata of the file a user is attempting to upload, cache program 57 references the file stored to information repository 37. In an embodiment, cache program 57 references the file previously saved to information repository 53 by providing a link (or other method) that directs user receiving the link to the file that was previously saved to information repository 53. In an embodiment, cache program 57 saves metadata to files saved to information repository 53. For example, cache program 57 saves the name of the user that uploaded the file when cache program 57 saves an uploaded file to information repository 53.

In an embodiment, cache program 57 retrieves the list of users involved in the action from the social graph to store the list of retrieved users associated with the action. In an embodiment, cache program 57 uses an algorithm that illustrates the distance between a user and the other users within the social network. For example, User B is a friend of User A. User B is in the sub-network of User A. The distance between User A and User B is one. User C is a friend of User B. User C is in the sub-network of User B. The distance between User A and User C is two. The greater the frequency of interactions between users in the social graph, the stronger the connection between the users in the social graph. In an embodiment, the user of computing device 30 customizes the distance in relationships between users that cache program 57 searches on the social graph. In other words, cache program 57 receives input from the user of computing device 30 that indicates that cache program 57 is to retrieve a list of users within a certain distance of the user of computing device 30 within the social graph of the user of computing device 30 or within a certain distance of another user. For example, cache program 57 receives input from the user of computing device 30 that cache program 57 is to search metadata for users within a distance of five users from the user of computing device 30. In another embodiment, cache program 57 has a default setting for the distance that cache program 57 searches on the social graph. For example, by default, cache program 57 searches metadata for users within a distance of three users from the user of computing device 30. In other embodiments, cache program 57 uses an algorithm to determine the distance cache program 57 will search on the social graph. In an embodiment, cache program 57 identifies files stored to information repository 53. For example, cache program 57 searches information repository 53 for a stored file that is a match to a file received by cache program 57. In an embodiment, each time a reference link for a file is used, cache program 57 modifies the metadata associated with the file to include the use. In an embodiment, cache program 57 compares the metadata of files stored in information repository 53 to the metadata in a file that was recently uploaded to determine a match.

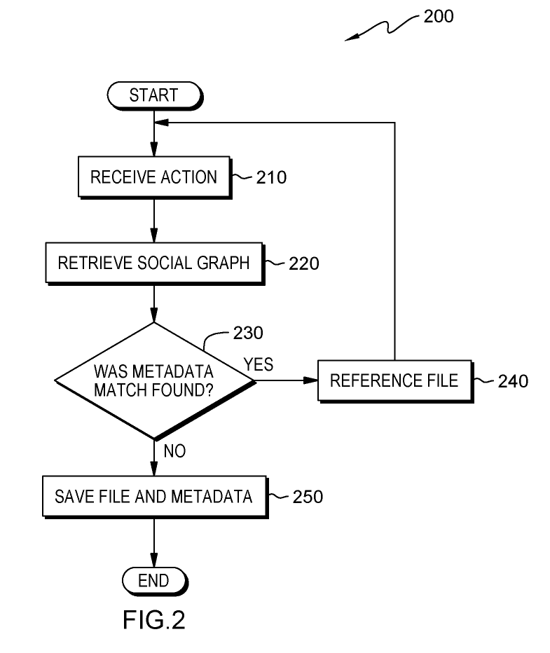

FIG. 2 depicts a flowchart of operational steps 200 of cache program 57 executing within the computing environment of FIG. 1, in accordance with an embodiment of the present invention. Cache program 57 operates to save and reference shared files. In an embodiment, the steps of the workflow are performed by cache program 57. Alternatively, steps of the workflow can be performed by any other program while working with cache program 57. A user can invoke operational steps 200 by uploading a file to server 50 to send to another user.

In an embodiment, cache program 57 receives an indication that a user of computing device 30 wants to upload a file to server 50 and send that file with another user in network 20. Cache program 57 searches information repository 53 for a matching file that was previously uploaded and saved to information repository 53. If cache program 57 determines that a matching file was previously stored to information repository 53, cache program 57 references the previously stored matching file instead of uploading the same file again. In an embodiment, network 20 can be any type of network. For example, network 20 may be part of a social media network or a data sharing website.

In step 210, cache program 57 receives an action. In other words, cache program 57 receives an indication of an action, via UI 33, from the user of computing device 30. For example, the action (or indication) may be an operation that adds a file to information repository 53 of a social network or any other type of network for uploading, transferring, and sharing files In an embodiment, the action includes uploads and any other operation that requires a file upload of distribution. In an embodiment, a social network is a platform (e.g., a dedicated website or other application) that enables users to communicate with one another by posting and/or sharing information, comments, messages, images, etc. In an embodiment, users have a sub-network that includes other users. For example, social Network A has a total of 25 million registered users, and User A has an account with Social Network A. User A has a sub-network that includes 150 users that have an account with Social Network A. The users within the sub-network of User A include friends, family, and colleagues of User A.

In an embodiment, cache program 57 receives an indication that the user of computing device 30 wants to send the user of computing device 40 a file. In embodiment, the user of computing device 30 wants to send a file with the user of computing device 40 via a social network. In an embodiment, cache program 57 can receive an indication from any computing device that is accessible to cache program 57. In an embodiment, the file may be any file that computing device 30 is capable of sending (e.g., a digital photograph with a .JPEG extension). For example, cache program 57 receives an indication from the user of computing device 30 that the user of computing device 30 wants to send a digital photograph to the user of computing device 40.

In step 220, cache program 57 retrieves the social graph. In an embodiment, cache program 57 retrieves the social graph of the user of computing device 30 when cache program 57 receives an indication from the user of computing device 30. In another embodiment, cache program 57 retrieves the social graph of the user of computing device 30 and the social graph of the user of computing device 40. In other words, the social graph of the user sending the file and the social graph of the user receiving the file. In other embodiments, cache program 57 retrieves the social graph of the user of computing device 40. In an embodiment, a social graph is a group of users that are in a sub-network of a particular user. For example, User A has a sub-network. The users in the sub-network of User A form a social graph, depicting the relationships User A has with individuals in the sub-network of User A. In an embodiment, a social graph is a mapping of how people are related to one another. In an embodiment, the more the user of computing device 30 interacts with another user in network 20, the stronger the connection will be between the users in the social graph. For example, sending a photo or transferring a file is an interaction.

In an embodiment, the social graph can be divided by the strength of the interactions. For example, the more frequent the user of computing device 30 interacts with a user within the social graph, the closer the connection is between the user of computing device 30 and another user within the social graph of the user of computing device 30. In an embodiment, there can be any number of subgroups that vary in strength to the user. In an embodiment, the sup-groups of a social graph are ranked. The more interactions a sub-group has with a user, the more highly ranked the sub-group will be. In an embodiment, cache program 57 determines the identity of some or all of the users in the retrieved social graph. For example, cache program 57 retrieves the most highly ranked tier of users in the social graph of the user of computing device 30.

In decision block 230, cache program 57 determines if a metadata match was found. In an embodiment, cache program 57 determines if a file saved to information repository 37 has metadata that matches the file that the user of computing device 30 is attempting to upload. In an embodiment, cache program 57 determines if a user in the social graph of the user of computing device 30 recently sent or received a file saved to information repository 37 that matches the file that the user of computing device 30 is attempting to upload. In another embodiment, cache program 57 searches the metadata of files saved to information repository 37 that are associated with the users in the social graph of the user of computing device 30 and users in the social graph of the intended recipient of the file that the user of computing device 30 is attempting to upload. For example, cache program 57 receives an indication that the user of computing device 30 is attempting to upload and send a photo with the user of computing device 40. Cache program 57 searches the metadata of files stored to information repository 53 that were uploaded or received by users in the social graph of the user of computing device 30 and users in the social graph of the user of computing device 40. In an embodiment, cache program 57 searches the metadata of all files saved to information repository 53 that are associated with users in a social graph. In another embodiment, cache program 57 searches the metadata a subset of files saved to information repository 53 that are associated with users in a social graph. For example, cache program 57 searches the metadata of files that were uploaded or received by users in the highest ranked tier in a social graph of a user.

In an embodiment, cache program 57 compares the metadata of the file that the user of computing device 30 is attempting to upload with the metadata of files that were previously uploaded and stored to information repository 53. In an embodiment, cache program 57 compares the metadata of files to determine if a match was found between two or more files was found. Cache program 57 searches the metadata of the files of the users found in the retrieved social graph(s), as previously discussed.

In an embodiment, cache program 57 searches the metadata of the previously uploaded files for data that includes, but is not limited to, the name of the file, the type of file, the type of extension that is associated with the file, the size of the file, the name of creator(s) and/or editor(s) of the files, the date and/or time the file was created and/or edited, and any other data that would identify a matching file. In an embodiment, cache program 57 uses one criterion to determine if a match was found (e.g., a unique ID or the name of the file). In another embodiment, cache program 57 uses more than one criterion to determine if a match was found. For example, cache program 57 determines if a match was found by comparing the name of files, the name of the creator of the file, and the date and time the file was created. In an embodiment, cache program 57 compares the entire contents of two or more files to determine if the metadata of the file the user of computing device 30 is attempting to upload is an identical match to the metadata of another file that was previously stored to information repository 53.

If cache program 57 determines that a match was found (decision block 230, yes branch), cache program 57 references the file (step 240). In an embodiment, cache program 57 references the file with matching metadata that is stored to information repository (decision block 230) with a link that directs the user of computing device 40 to the file with matching metadata stored to information repository 53. For example, cache program 57 receives an indication that user A is attempting to upload and send a file to User B. Cache program searches information repository 53 for a file with metadata that matches the metadata of the file User A is attempting to upload. Cache program 57 determines there is a file in information repository 53 with corresponding metadata that matches the metadata of the file User A is attempting to upload. Cache program 57 sends User B a reference link that directs User B to the file with matching metadata that was previously stored to information repository 53. Cache program does not save the uploaded file to information repository 53 since a copy of the file is already stored to information repository 53 from a previous upload. In an embodiment, cache program 57 adds metadata to the stored file that describe the actions that were performed on the file. For example, cache program 57 stores the name of the users that upload, send, or interact in any way with the stored file. After cache program 57 references the link, processing proceeds to step 210.

If cache program 57 determines that a match was not found (decision block 230, no branch), cache program 57 saves the file and metadata (step 250). In an embodiment, cache program 57 saves a copy of the uploaded file along with metadata about the file to information repository 53. The metadata may include, but is not limited to, the (name of the) user that uploaded the file, the type of file that was uploaded, the contents of the uploaded file, the file name of the uploaded file, the user that received the file, users that comment or edit the file, and a reference link that is associated with the uploaded file (e.g., a URL that redirects a user to the original file). In an embodiment, cache program 57 generates a reference link for future received actions to minimize the amount of data that is stored to information repository 53. In an embodiment, cache program 57 generates a link that enables faster transfer of a file. For example, it is faster for cache program 57 to reference an existing link to a previously uploaded copy of a file than to wait for the file to upload and then send a link to the newly uploaded file. In an embodiment, cache program 57 saves the metadata in a separate file from the uploaded file. In another embodiment, cache program 57 saves the metadata to the same file as the copy of the uploaded file. In an embodiment, cache program 57 saves a list of relevant users to the metadata of the stored file. In an embodiment, cache program 57 notifies the user that a reference link was used. In an embodiment, cache program 57 notifies the user of computing device 30 that a reference link was sent to user of computing device 40. In another embodiment, cache program 57 sends the user of computing device 40 a reference link without notifying the user of computing device 30. Processing ends when cache program 57 stores the uploaded file and metadata to information repository 53.

In an example embodiment, a group of users are connected to one another in a social media website. Within the social media website, the users are represented in a social graph, which depicts how the users are related to one another. User A is connected to a group of people on a social media website. User A wants to send a photo with User B on the social media website. Cache program 57 receives an indication, via UI 33, that User A wants to send the photo with User B. Cache program 57 retrieves the social graph of User A and the social graph of user B to determine if a user in either social graph recently sent or received a file that matches the file that User A wants to upload. To determine if a user recently sent or received a photo with corresponding metadata that matches the photo User A wants to send with User B, cache program 57 searches the metadata of files stored to information repository 53 that were sent or received by all of the users in the social graphs of User A and User B. Cache program 57 determines that User C in the social graph of User A recently shared the same photo with User A. Cache program 57 does not upload the photo that User A wants to send with User B. Instead, cache program 57 sends User B a link that will direct User B to the photo originally uploaded and stored to information repository 53 when User C uploaded the photo previously. After cache program 57 sends User B the link, cache program 57 waits to receive an interaction from another user on the social media site.

In another example, cache program 57 receives an indication that User A wants to send a PDF file with User B. Cache program 57 retrieves the social graphs of User A and the social graph of User B. The social graph is divided into tiers. The more frequently a user interacts with other users in the social graph, the stronger the connection the user has to those other users in the social graph. The highest ranked tier is the tier that includes users a user has the most interactions with. Cache program 57 searches the metadata of files from users in the highest ranked tier in the social graph of User A and the highest ranked tier in the social graph of User B. Cache program 57 does not find a file associated with the users in the highest ranked tier of User B or associated with users in the highest ranked tier of User A that was previously stored to information repository 53 with corresponding metadata that matches the metadata of the PDF file User A wants to send with User B. Cache program 57 uploads the PDF and saves a copy of the PDF to information repository 53. When cache program 57 saves the PDF to information repository 53, cache program 57 saves metadata to the file that indicates that User A uploaded and shared the PDF with User B. Cache program 57 also a list of relevant users to the metadata.

FIG. 3 depicts computer system 300, which is an example of a system that includes cache program 57. Computer system 300 includes processors 301, cache 303, memory 302, persistent storage 305, communications unit 307, input/output (I/O) interface(s) 306 and communications fabric 304. Communications fabric 304 provides communications between cache 303, memory 302, persistent storage 305, communications unit 307, and input/output (I/O) interface(s) 306. Communications fabric 304 can be implemented with any architecture designed for passing data and/or control information between processors (such as microprocessors, communications and network processors, etc.), system memory, peripheral devices, and any other hardware components within a system. For example, communications fabric 304 can be implemented with one or more buses or a crossbar switch.

Memory 302 and persistent storage 305 are computer readable storage media. In this embodiment, memory 302 includes random access memory (RAM). In general, memory 302 can include any suitable volatile or non-volatile computer readable storage media. Cache 303 is a fast memory that enhances the performance of processors 301 by holding recently accessed data, and data near recently accessed data, from memory 302.

Program instructions and data used to practice embodiments of the present invention may be stored in persistent storage 305 and in memory 302 for execution by one or more of the respective processors 301 via cache 303. In an embodiment, persistent storage 305 includes a magnetic hard disk drive. Alternatively, or in addition to a magnetic hard disk drive, persistent storage 305 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 305 may also be removable. For example, a removable hard drive may be used for persistent storage 305. Other examples include optical and magnetic disks, thumb drives, and smart cards that are inserted into a drive for transfer onto another computer readable storage medium that is also part of persistent storage 305.

Communications unit 307, in these examples, provides for communications with other data processing systems or devices. In these examples, communications unit 307 includes one or more network interface cards. Communications unit 307 may provide communications through the use of either or both physical and wireless communications links. Program instructions and data used to practice embodiments of the present invention may be downloaded to persistent storage 305 through communications unit 307.

I/O interface(s) 306 allows for input and output of data with other devices that may be connected to each computer system. For example, I/O interface 306 may provide a connection to external devices 308 such as a keyboard, keypad, a touch screen, and/or some other suitable input device. External devices 308 can also include portable computer readable storage media such as, for example, thumb drives, portable optical or magnetic disks, and memory cards. Software and data used to practice embodiments of the present invention can be stored on such portable computer readable storage media and can be loaded onto persistent storage x05 via I/O interface(s) 306. I/O interface(s) 306 also connect to display 309.

Display 309 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for storing and referencing shared files, the method comprising:
receiving, by one or more computer processors, an indication from a first user, wherein the indication includes uploading a first file to transfer the first file from the first user to a second user;
determining, by one or more computer processors, a social graph;
determining, by one or more computer processors, whether the first file is stored in a repository associated with any user found in the social graph;
responsive to determining the first file is stored in the repository of any of the users found in the social graph, transmitting, by one or more computer processors, a link to the first file found in the repository to the second user;
responsive to determining the first file is not stored in the repository of any of the users found in the social graph, uploading, by one or more computer processors, the first file; and
responsive to uploading the first file, transmitting, by one or more computer processors, the uploaded first file to the second user.

2. The method of claim 1, wherein the social graph is a social graph associated with the first user.

3. The method of claim 1, wherein the social graph is a social graph associated with the second user.

4. The method of claim 1, wherein the social graph is a first social graph associated with the first user and a second social graph associated with the second user.

5. The method of claim 1, further comprises:
wherein the step of determining whether the first file is stored in a repository associated with any user found in the social graph comprises:
determining, by one or more computer processors, at least one repository associated with any user found in the social graph; and
determining, by one or more computer processors, whether any files in the determined at least one repository has at least one identical metadata of the first file, wherein the metadata are one or more of the following: a name of the first file, a size of the first file, an author of the first file, a date the first file was created, and a unique identification of the first file;
wherein the step of responsive to determining the first file is stored in the repository of any of the users found in the social graph, transmitting, by one or more computer processors, a link to the first file found in the repository to the second user comprises:
responsive to determining a second file in the determined at least one repository has at least one identical metadata of the first file, transmitting, by one or more computer processors, a link to the second file found in the repository to the second user; and
wherein the steps of responsive to determining the first file is not stored in the repository of any of the users found in the social graph, uploading, by one or more computer processors, the first file; and responsive to uploading the first file, transmitting, by one or more computer processors, the uploaded first file to the second user comprise:
responsive to determining any file in the determined at least one repository does not have at least one identical metadata of the first file, uploading, by one or more computer processors, the first file; and
responsive to uploading the first file, transmitting, by one or more computer processors, the uploaded first file to the second user.

6. The method of claim 1, wherein the social graph is one or more users that are connected to one another on a social network.

7. A computer program product for storing and referencing shared files, the computer program product comprising:
one or more computer readable storage media; and
program instructions stored on the one or more computer readable storage media, the program instructions comprising:
program instructions to receive an indication from a first user, wherein the indication includes uploading a first file to transfer the first file from the first user to a second user;
program instructions to determine a social graph;
program instructions to determine whether the first file is stored in a repository associated with any user found in the social graph;
responsive to determining the first file is stored in the repository of any of the users found in the social graph, program instructions to transmit a link to the first file found in the repository to the second user;
responsive to determining the first file is not stored in the repository of any of the users found in the social graph, program instructions to upload the first file; and
responsive to uploading the first file, program instructions to transmit the uploaded first file to the second user.

8. The computer program product of claim 7, wherein the social graph is a social graph associated with the first user.

9. The computer program product of claim 7, wherein the social graph is a social graph associated with the second user.

10. The computer program product of claim 7, wherein the social graph is a first social graph associated with the first user and a second social graph associated with the second user.

11. The computer program product of claim 7, further comprising:
wherein the program instructions to determine whether the first file is stored in a repository associated with any user found in the social graph comprises:
program instructions to determine at least one repository associated with any user found in the social graph; and
program instructions to determine whether any files in the determined at least one repository has at least one identical metadata of the first file, wherein the metadata are one or more of the following: a name of the first file, a size of the first file, an author of the first file, a date the first file was created, and a unique identification of the first file;
wherein responsive to determining the first file is stored in the repository of any of the users found in the social graph, program instructions to transmit a link to the first file found in the repository to the second user comprises:
responsive to determining a second file in the determined at least one repository has at least one identical metadata of the first file, program instructions to transmit a link to the second file found in the repository to the second user; and
wherein responsive to determining the first file is not stored in the repository of any of the users found in the social graph, program instructions to upload the first file; and responsive to uploading the first file, program instructions to transmit the uploaded first file to the second user comprise:
responsive to determining any file in the determined at least one repository does not have at least one identical metadata of the first file, program instructions to upload the first file; and
responsive to uploading the first file, program instructions to transmit the uploaded first file to the second user.

12. The computer program product of claim 7, wherein the social graph is one or more users that are connected to one another on a social network.

13. A computer system for storing and referencing shared files, the computer system comprising:
one or more computer processors;
one or more computer readable storage media; and
program instructions stored on the one or more computer readable storage media for execution by at least one of the one or more processors, the program instructions comprising:
program instructions to receive an indication from a first user, wherein the indication includes uploading a first file to transfer the first file from the first user to a second user;
program instructions to determine a social graph;
program instructions to determine whether the first file is stored in a repository associated with any user found in the social graph;
responsive to determining the first file is stored in the repository of any of the users found in the social graph, program instructions to transmit a link to the first file found in the repository to the second user;
responsive to determining the first file is not stored in the repository of any of the users found in the social graph, program instructions to upload the first file; and
responsive to uploading the first file, program instructions to transmit the uploaded first file to the second user.

14. The computer system of claim 13, wherein the social graph is a social graph associated with the first user.

15. The computer system of claim 13, wherein the social graph is a social graph associated with the second user.

16. The computer system of claim 13, wherein the social graph is a first social graph associated with the first user and a second social graph associated with the second user.

17. The computer system of claim 13, further comprising:
wherein the program instructions to determine whether the first file is stored in a repository associated with any user found in the social graph comprises:
program instructions to determine at least one repository associated with any user found in the social graph; and
program instructions to determine whether any files in the determined at least one repository has at least one identical metadata of the first file, wherein the metadata are one or more of the following: a name of the first file, a size of the first file, an author of the first file, a date the first file was created, and a unique identification of the first file;
wherein responsive to determining the first file is stored in the repository of any of the users found in the social graph, program instructions to transmit a link to the first file found in the repository to the second user comprises:
responsive to determining a second file in the determined at least one repository has at least one identical metadata of the first file, program instructions to transmit a link to the second file found in the repository to the second user; and
wherein responsive to determining the first file is not stored in the repository of any of the users found in the social graph, program instructions to upload the first file; and responsive to uploading the first file, program instructions to transmit the uploaded first file to the second user comprise:
responsive to determining any file in the determined at least one repository does not have at least one identical metadata of the first file, program instructions to upload the first file; and
responsive to uploading the first file, program instructions to transmit the uploaded first file to the second user.

18. The computer system of claim 13, wherein the social graph is one or more users that are connected to one another on a social network.
